(19) United States
(12) Patent Application Publication
(10) Pub. No.: US 2026/0351873 A1
(43) Pub. Date: Nov. 5, 2026

(54) TERMINAL STRUCTURE FOR ELECTRONIC COMPONENTS

(71) Applicant: Dongguan Littelfuse Electronics Company Limited, Dongguan City (CN)

(72) Inventors: Dalong Chen, Dongguan City (CN); Hailang Tang, Dongguan City (CN); Hui Li, Dongguan City (CN)

(73) Assignee: Dongguan Littelfuse Electronics Company Limited, Dongguan City (CN)

(21) Appl. No.: 19/662,275

(22) Filed: Apr. 29, 2026

(30) Foreign Application Priority Data
Apr. 30, 2025 (CN) 202510572638.0

(51) Int. Cl. H01R 12/57; H01C 1/014; H01C 1/034; H01C 1/144; H01C 7/108

(52) U.S. Cl. CPC H01R 12/57; H01C 1/014; H01C 1/034; H01C 1/144; H01C 7/108

(57) ABSTRACT

A surface mount device including an electronic component having a first electrode disposed on a first side of thereof and a second electrode disposed on a second side thereof, a first terminal connected to the first electrode and a second terminal connected to the second electrode, wherein each of the first terminal and the second terminal includes a foot portion adapted to be connected to a contact on a printed circuit board, a connection portion connected to a respective one of the first electrode and the second electrode, and an intermediate portion extending between the foot portion and the connection portion, the intermediate portion including a plurality of bends formed therein, and an embossment formed therein, wherein the embossment extends through at least one of the plurality of bends.

### CROSS-REFERENCE TO RELATED APPLICATIONS

This application claims the benefit of priority to, Chinese Patent Application No. 202510572638.0, filed Apr. 30, 2025, entitled “IMPROVED TERMINAL STRUCTURE FOR ELECTRONIC COMPONENTS,” which application is incorporated herein by reference in its entirety.

### FIELD

The present disclosure relates generally to the field of surface mount devices. More specifically, the present disclosure relates to terminal structures for surface mount devices, wherein the terminal structures have improved resistance to deformation and skewing when a protective coating is overmolded thereon.

### DESCRIPTION OF RELATED ART

Surface mount devices (“SMDs”) typically include electrically conductive terminals that facilitate mechanical and electrical connection of an electronic component (e.g., a metal oxide varistor, a fuse, etc.) to a circuit board. For example, a typical metal oxide varistor (“MOV”) includes a MOV chip having first and second electrodes disposed on opposing sides thereof. Electrically conductive first and second terminals may be soldered to the first and second electrodes, respectively. The first and second terminals may include pads or feet that can be soldered to respective contacts on a circuit board. A protective coating, typically formed of epoxy, can be overmolded onto the MOV and the first and second terminals (e.g., via injection molding) to provide a barrier against external contaminants and to prevent electrical arcing between the MOV and surrounding components.

A problem associated with configurations such as the one described above is that, when the protective coating is applied using an injection molding process or the like, the flow of overmolding material can exert forces on the electronic component and on the terminals being coated, causing the terminals to deform (e.g., bend or deflect), resulting in undesirable skewing of the terminals and the electronic component. This problem is especially prevalent in cases where an electronic component is installed in a vertical orientation, with the greatest dimension of the electronic component extending perpendicularly from a circuit board, such as for the purpose of minimizing the footprint of the electronic component on the circuit board. Vertical installation generally necessitates longer terminals that are more prone to skewing than shorter terminals. If such skewing is severe, it may be necessary to reject the SMD as defective, resulting in waste and increased cost.

In view of the above, it would be desirable to provide a SMD having terminals that are resistant to deformation and skewing.

### SUMMARY

This Summary is provided to introduce a selection of concepts in a simplified form further described below in the Detailed Description. This Summary is not intended to identify key features or essential features of the claimed subject matter, nor is the summary intended as an aid in determining the scope of the claimed subject matter.

An embodiment of a surface mount device in accordance with the present disclosure may include an electronic component having a first electrode disposed on a first side of thereof and a second electrode disposed on a second side thereof, a first terminal connected to the first electrode and a second terminal connected to the second electrode, wherein each of the first terminal and the second terminal includes a foot portion adapted to be connected to a contact on a printed circuit board, a connection portion connected to a respective one of the first electrode and the second electrode, and an intermediate portion extending between the foot portion and the connection portion, the intermediate portion including a plurality of bends formed therein, and an embossment formed therein, wherein the embossment extends through at least one of the plurality of bends.

An embodiment of a terminal for a surface mount device in accordance with the present disclosure may include a foot portion adapted to be connected to a contact on a printed circuit board, a connection portion adapted to be connected to an electrode of an electronic component, and an intermediate portion extending between the foot portion and the connection portion, the intermediate portion including a plurality of bends formed therein, and an embossment formed therein, wherein the embossment extends through at least one of the plurality of bends.

### BRIEF DESCRIPTION OF THE DRAWINGS

By way of example, various embodiments of the present disclosure will now be described, with reference to the accompanying drawings, wherein:

FIG. 1A is a perspective view illustrating a surface mount device in accordance with an embodiment of the present disclosure;

FIG. 1B is another perspective view illustrating the surface mount device of FIG. 1A;

FIG. 2 is perspective view illustrating the surface mount device of FIGS. 1A and 1B with a protective coating;

FIG. 3 is a perspective view illustrating another surface mount device in accordance with an embodiment of the present disclosure.

### DETAILED DESCRIPTION

Exemplary embodiments of a surface mount device will now be described more fully hereinafter with reference to the accompanying drawings. The surface mount device may, however, be embodied in many different forms and should not be construed as being limited to the embodiments set forth herein. Rather, these embodiments are provided so that this disclosure will convey certain exemplary aspects of the surface mount device to those skilled in the art.

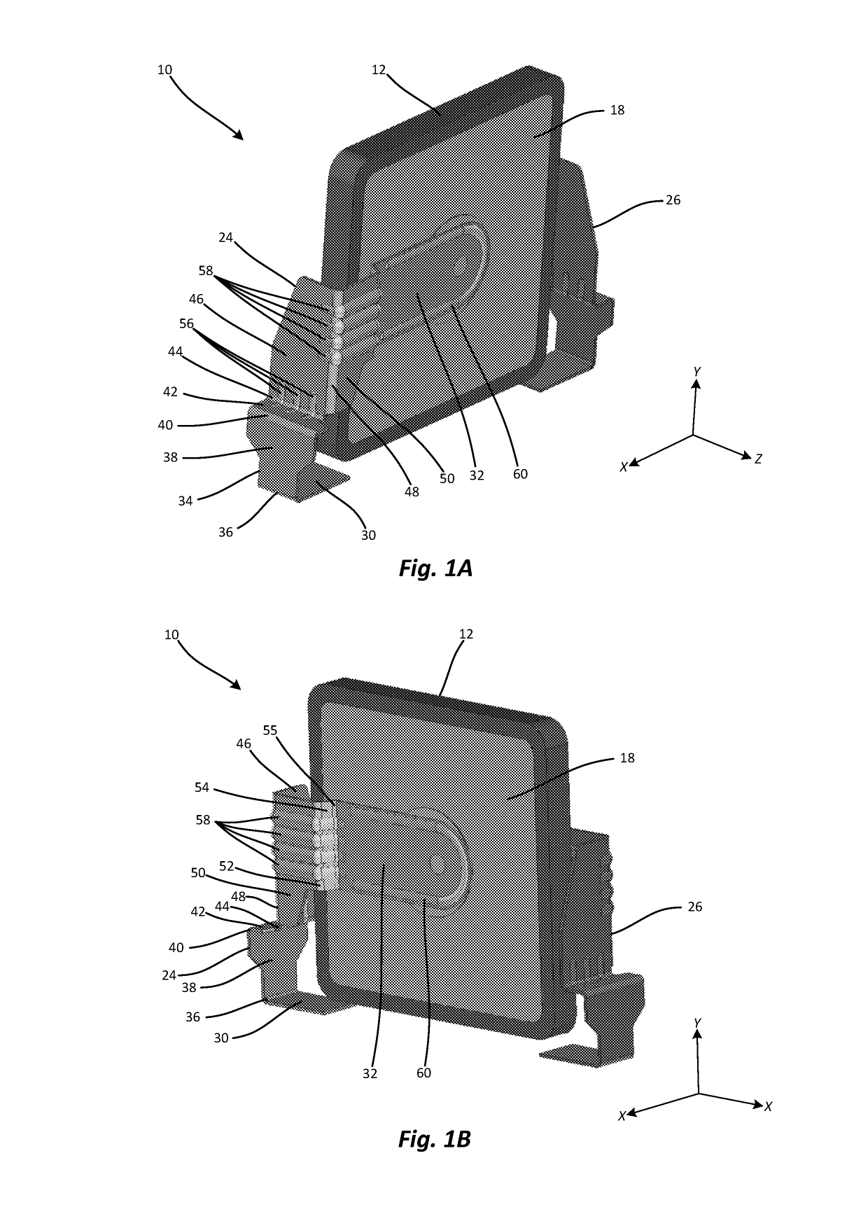

Referring to FIGS. 1A and 1B, perspective views illustrating a surface mount device 10 (hereinafter “the SMD 10”) according to an embodiment of the present disclosure are shown. The SMD 10 may include an electronic component 12 (hereinafter “the component 12”) and electrically conductive first and second terminals 24, 26. The component 12 may be or may include any type of electronic component commonly mounted on a printed circuit board (PCB). In the exemplary embodiment illustrated in FIGS. 1A and 1B, the component 12 is a metal oxide varistor (MOV). In other embodiments, the component 12 may be a fuse, a diode, a thermistor, etc. The present disclosure is not limited in this regard. The electronic component 12 may include a first electrode 18 and a second electrode located on opposite sides of the electronic component 12 (the second electrode is not within view but is generally identical to the first electrode 18). The term “electrode” is used generically herein to refer to any type of electrically conductive contact, terminal, pole, or connection point of an electronic component. The first and second electrodes may be generally planar and may be formed of layers or films of metal (e.g., silver, gold, copper, copper, tin, nickel, aluminum, etc.). The present disclosure is not limited in this regard.

The first and second terminals 24, 26 of the SMD 10 may facilitate electrical connection of the electronic component 12 within a circuit as further described below. The first and second terminals 24, 26 may be formed of a metal having good electrical conductivity. Examples of such metals include, but are not limited to, copper, tin, aluminum, etc. The first terminal 24 may be electrically and mechanically connected to the first electrode 18 of the electronic component 12, and the second terminal 26 may be electrically and mechanically connected to the second electrode (not within view) of the electronic component 12. The first and second terminals 24, 26 and their respective orientations and connections to the first and second electrodes may be generally identical. As such, only the first terminal 24 and its orientation and connection to the first electrode 18 will be described in greater detail herein, and it will be understood that such description shall also apply the second terminal 26 and its orientation and connection to the second electrode.

The first terminal 24 may be cut, pressed, or otherwise formed from a single sheet of metal, and may include a planar foot portion 30 adapted to be soldered to a contact on a PCB. The first terminal 24 may further include a planar connection portion 32 soldered to the first electrode 18 of the electronic component 12 as further described below. The first terminal 24 may further include an intermediate portion 34 extending between the foot portion 30 and the connection portion 32. The foot portion 30 may lie in a horizontal plane, parallel to the X-Z plane of the Cartesian coordinate system shown in FIGS. 1A and 1B. The connection portion 32 may lie in a vertical plane, parallel to the X-Y plane of the Cartesian coordinate system shown in FIGS. 1A and 1B and perpendicular to the plane of the foot portion 30. The intermediate portion 34 may include plurality of bends or folds formed therein that define a plurality of segments extending along various planes. For example, the intermediate portion 34 may include a first bend 36, wherefrom a first segment 38 extends perpendicularly from the foot portion 30, a second bend 40, wherefrom a second segment 42 extends form the first segment 38, a third bend 44, wherefrom a third segment 46 extends form the second segment 42, a fourth bend 48, wherefrom a fourth segment 50 extends form the third segment 46, and a fifth bend 52, wherefrom a fifth segment 54 extends form the fourth segment 50, and a sixth bend 55, wherefrom the connection portion 32 extends from the fifth segment 54. The aforementioned bends and segments serve to facilitate the necessary positions and orientations of the foot portion 30 and the connection portion 32 relative to one another for allowing connections to a PCB (not shown) and to the first electrode 18 of the vertically oriented electronic component 12, respectively. It will be appreciated that the specific positions, orientations, and total number of the bends and segments described above and shown in FIGS. 1A and 1B are not intended to be limiting and may be varied to suit a particular application without departing from the scope of the present disclosure.

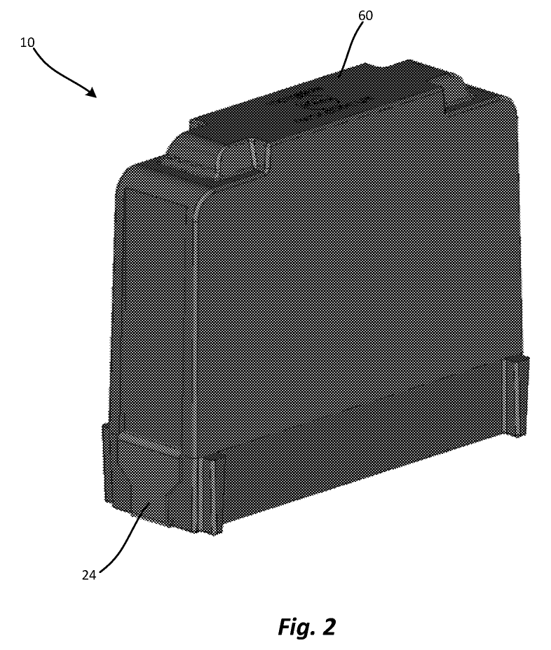

The intermediate portion 34 may further include corrugations or embossments formed therein that extend through certain of the above-described bends and between certain of the above-described segments. For example, the intermediate portion 34 may include one or more embossments 56 that extend through the third bend 44, from the second segment 42 into the third segment 46. The intermediate portion 34 may further include one or more embossments 58 that extend through the fourth, fifth, and sixth bends 48, 52, 55, from the third segment 46, through the fourth segment 50, and into the fifth segment 54. The embossments 56, 58 may provide the intermediate portion 34 with enhanced strength and rigidity at the third, fourth, fifth, and sixth bends 44, 48, 52, 55. Thus, when a protective coating 60 (see FIG. 2) is overmolded onto the electronic component 12 and the first and second terminals 24, 26 (e.g., via an injection molding process), the first and second terminals 24, 26 may exhibit improved resistance to bending, deflection, or deformation under the force of the overmolding material (e.g., epoxy) being applied thereto. Undesirable skewing of the first and second terminals 24, 26 and the electronic component 12 is thereby mitigated, reducing waste and expense that would otherwise result from a defective device. Moreover, the enhanced strength and rigidity provided by the embossments allows the first and second terminals 24, 26 to be thinner than traditional terminals (i.e., formed from sheets of metal that are thinner than those used to fabricate traditional terminals), thereby reducing the cost of the first and second terminals 24, 26 relative to traditional terminals. For example, the first and second terminals 24, 26 may have a thickness in a range of 0.15 millimeters to 0.30 millimeters. The present disclosure is not limited in this regard.

In various embodiments, the planar connection portion 32 of the first terminal 24 may include one or embossments formed therein. For example, as shown in FIG. 1A, the connection portion 32 may include a U-shaped embossment 60 defining an underlying channel, recess, or pocket (hereinafter “the recess”) that confronts the first electrode 18 of the electronic component 12 and that at least partially surrounds an area of the connection portion 32 that is soldered to the first electrode 18. Thus, when the connection portion 32 is soldered to the first electrode 18, the recess defined by the embossment 60 may collect excess solder reflow that could otherwise leak or spread out from between the connection portion 32 and the first electrode 18. Defects and reliability issues associated with such solder reflow leakage are thereby mitigated.

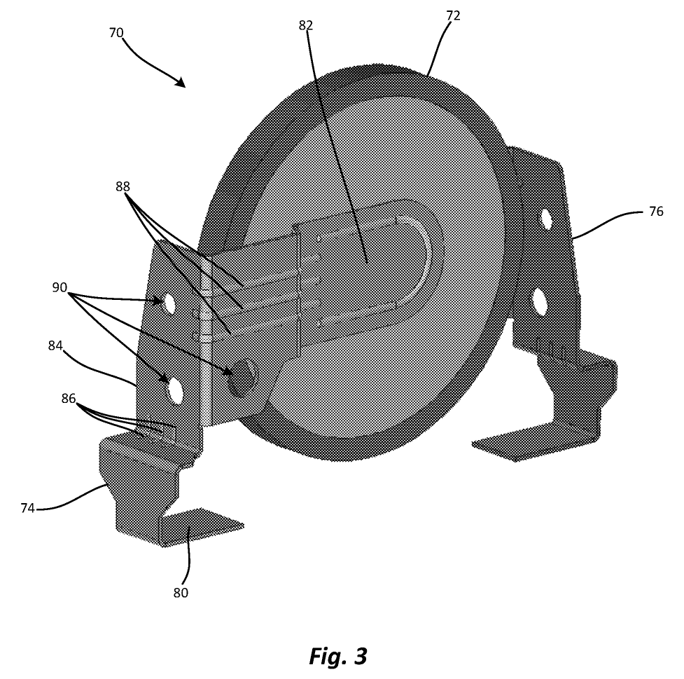

Referring to FIG. 3, a perspective view illustrating a surface mount device 70 (hereinafter “the SMD 70”) according to another embodiment of the present disclosure is shown. The SMD 10 may be substantially similar to the SMD 10 described above and may similarly include an electronic component 72 and first and second terminals 74, 76. The first and second terminals 74, 76 may be generally identical. As such, only the first terminal 74 will be described in greater detail herein, and it will be understood that such description shall also apply the second terminal 76.

The first terminal 74 may be substantially similar to the first terminal 24 of the SMD 10 described above, and may similarly include a foot portion 80, a connection portion 82, and an intermediate portion 84 extending between the foot portion 80 and the connection portion 82. The intermediate portion 84 may include embossments 86, 88 similar to the embossments 56, 58 described above. The intermediate portion 84 may further include one or more apertures 90 formed therein. For example, as shown in FIG. 3, the intermediate portion 84 may include three round apertures 90 formed therein. The present disclosure is not limited in this regard, and the size, shape, location, and number of the apertures 90 may be varied in alternative embodiments. When a protective coating is overmolded onto the electronic component 72 and the first and second terminals 74, 76 (e.g., via an injection molding process), the overmolding material (e.g., epoxy) may flow through the apertures 90, thereby reducing the resistance of the first and second terminals 74, 76 to the force exerted thereon by the flow of the overmolding material. The apertures 90 may therefore make the first and second terminals 74, 76 less prone to bending, deflection, or deformation under the force of the overmolding material. Undesirable skewing of the first and second terminals 74, 76 and the electronic component 72 is thereby mitigated, reducing waste and expense that would otherwise result from a defective device. Moreover, the improved resistance to deformation provided by the apertures 90 allows the first and second terminals 74, 76 to be thinner than traditional terminals (i.e., formed from sheets of metal that are thinner than those used to fabricate traditional terminals), thereby reducing the cost of the first and second terminals 74, 76 relative to traditional terminals. In various embodiments, the embossments 86, 88 in the intermediate portion 84 may be omitted, with only the apertures 90 provided to enhance the resistance of the first and second terminals 74, 76 to deformation. The present disclosure is not limited in this regard.

As used herein, an element or step recited in the singular and proceeded with the word "a" or "an" should be understood as not excluding plural elements or steps, unless such exclusion is explicitly recited. Furthermore, references to "one embodiment" of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A surface mount device comprising:
an electronic component having a first electrode disposed on a first side of thereof and a second electrode disposed on a second side thereof;
a first terminal connected to the first electrode and a second terminal connected to the second electrode, wherein each of the first terminal and the second terminal comprises:
a foot portion adapted to be connected to a contact on a printed circuit board;
a connection portion connected to a respective one of the first electrode and the second electrode; and
an intermediate portion extending between the foot portion and the connection portion, the intermediate portion comprising:
a plurality of bends formed therein; and
an embossment formed therein, wherein the embossment extends through at least one of the plurality of bends.

2. The surface mount device of claim 1, wherein the foot portion is oriented perpendicular to the connection portion.

3. The surface mount device of claim 1, wherein the intermediate portion comprises: a first bend, wherefrom a first segment extends perpendicularly from the foot portion; a second bend, wherefrom a second segment extends form the first segment; a third bend, wherefrom a third segment extends form the second segment; a fourth bend, wherefrom a fourth segment extends form the third segment; and a fifth bend, wherefrom a fifth segment extends form the fourth segment; and a sixth bend, wherefrom the connection portion extends from the fifth segment.

4. The surface mount device of claim 1, wherein the connection portion of at least one of the first terminal and the second terminal includes an embossment formed therein, wherein the embossment in the connection portion defines a recess for collecting excess solder between the connection portion and a respective one of the first electrode and the second electrode.

5. The surface mount device of claim 4, wherein the embossment in the connection portion at least partially surrounds an area of the connection portion that is soldered to a respective one of the first electrode and the second electrode.

6. The surface mount device of claim 5, wherein the embossment in the connection portion is U-shaped.

7. The surface mount device of claim 1, further comprising a protective coating overmolded onto the electronic component and the first and second terminals.

8. The surface mount device of claim 1, wherein the intermediate portion includes an aperture formed therein.

9. The surface mount device of claim 1, wherein the first and second terminals have a thickness in a range of 0.15 millimeters to 0.30 millimeters.

10. The surface mount device of claim 1, wherein the each of the first and second terminals are formed from a single sheet of metal.

11. A terminal for a surface mount device, the terminal comprising:
a foot portion adapted to be connected to a contact on a printed circuit board;
a connection portion adapted to be connected to an electrode of an electronic component; and
an intermediate portion extending between the foot portion and the connection portion, the intermediate portion comprising:
a plurality of bends formed therein; and
an embossment formed therein, wherein the embossment extends through at least one of the plurality of bends.

12. The terminal of claim 11, wherein the foot portion is oriented perpendicular to the connection portion.

13. The terminal of claim 11, wherein the intermediate portion includes a first bend, wherefrom a first segment extends perpendicularly from the foot portion, a second bend, wherefrom a second segment extends form the first segment, a third bend, wherefrom a third segment extends form the second segment, a fourth bend, wherefrom a fourth segment extends form the third segment, and a fifth bend, wherefrom a fifth segment extends form the fourth segment, and a sixth bend, wherefrom the connection portion extends from the fifth segment.

14. The terminal of claim 11, wherein the connection portion includes an embossment formed therein, wherein the embossment in the connection portion defines a recess for collecting excess solder between the connection portion and an electrode of an electronic component.

15. The terminal of claim 14, wherein the embossment in the connection portion is U-shaped.

16. The terminal of claim 11, wherein the intermediate portion includes an aperture formed therein.

17. The terminal of claim 11, wherein the terminal has a thickness in a range of 0.15 millimeters to 0.30 millimeters.

18. The terminal of claim 11, wherein the terminal is formed from a single sheet of metal.
